(19) United States
(12) Patent Application Publication
(10) Pub. No.: US 2020/0105446 A1
(43) Pub. Date: Apr. 2, 2020

(54) SAMARIUM-IRON-BISMUTH-NITROGEN-BASED MAGNET POWDER AND SAMARIUM-IRON-BISMUTH-NITROGEN-BASED SINTERED MAGNET

(71) Applicants: Ryuji HASHIMOTO, Tokyo (JP); Yasushi Enokido, Tokyo (JP); Shusuke Okada, Aichi (JP); Kenta Takagi, Aichi (JP)

(72) Inventors: Ryuji HASHIMOTO, Tokyo (JP); Yasushi Enokido, Tokyo (JP); Shusuke Okada, Aichi (JP); Kenta Takagi, Aichi (JP)

(73) Assignees: TDK Corporation, Tokyo (JP); National Institute of Advanced Industrial Science and Technology, Tokyo (JP)

(21) Appl. No.: 16/582,349

(22) Filed: Sep. 25, 2019

(30) Foreign Application Priority Data
Sep. 28, 2018 (JP) 2018-183636
Sep. 24, 2019 (JP) 2019-173216

(51) Int. Cl. H01F 1/11

(52) U.S. Cl. CPC H01F 1/11

(57) ABSTRACT

A samarium-iron-bismuth-nitrogen-based magnet powder includes: a main phase including samarium, iron, and bismuth, wherein a ratio of bismuth to a total amount of samarium, iron, and bismuth is less than or equal to 3.0 at %.

### CROSS-REFERENCE TO RELATED APPLICATIONS

This application is based on and claims priority to Japanese Patent Application No. 2018-183636 filed on Sep. 28, 2018 and Japanese Patent Application No. 2019-173216 filed on Sep. 24, 2019. The entire contents of these applications are incorporated herein by reference.

### BACKGROUND OF THE INVENTION

### 1. Field of the Invention

The disclosures herein generally relate to a samarium-iron-bismuth-nitrogen-based magnet powder and a samarium-iron-bismuth-nitrogen-based sintered magnet.

### 2. Description of the Related Art

Samarium-iron-nitrogen magnets are expected to be high performance magnets because of having a high Curie temperature of 477° C., small magnetic properties change as a function of temperature, and a very high anisotropic magnetic field of 260 kOe, which is the theoretical value of coercivity.

Here, a samarium-iron-nitrogen magnet powder needs to be sintered to prepare a high performance magnet.

However, the decomposition temperature of the samarium-iron-nitrogen magnet powder is 620° C.

Therefore, as a powder for a permanent magnet that can be sintered, a samarium-iron-nitrogen magnet powder having a surface coated with bismuth is known (see Patent Document 1).

### RELATED-ART DOCUMENTS

### Patent Documents

[Patent Document 1] Japanese Laid-open Patent Publication No. H5-326229

However, when the surface of the samarium-iron-nitrogen magnet powder is coated with bismuth, there is a problem that the main phase decomposes and the coercivity decreases.

One aspect of the present invention has an object to provide a magnet powder having high coercivity and a high decomposition temperature.

### SUMMARY OF THE INVENTION

According to one aspect of the present invention, a samarium-iron-bismuth-nitrogen-based magnet powder includes a main phase including samarium, iron, and bismuth, wherein a ratio of bismuth to a total amount of samarium, iron, and bismuth is less than or equal to 3.0 at %.

According to one aspect of the present invention, it is possible to provide a magnet powder having a high coercivity and a high decomposition temperature.

### BRIEF DESCRIPTION OF THE DRAWINGS

FIG. 1 is a graph indicating the measurement result of the nitrogen release temperature of a samarium-iron-bismuth-nitrogen magnet powder of Example 1; and

FIG. 2 is a graph indicating the measurement result of the decomposition temperature of the samarium-iron-bismuth-nitrogen magnet powder of Example 1.

### DESCRIPTION OF THE PREFERRED EMBODIMENTS

In the following, an embodiment of the present invention will be described. Note that the present invention is not limited to the contents described in the following embodiment. Also, the components described in the following embodiment may include those that can be readily assumed by a person skilled in the art based on the components described in the following embodiment and may include those that are substantially identical to the components described in the embodiment. Additionally, the components described in the following embodiment may be suitably combined.

Although the decomposition temperature of a samarium-iron-nitrogen magnet powder is 620° C., because it is an interstitial compound where nitrogen enters between crystal lattices, low stability of the crystal structure is considered to have an effect.

The inventors of the present invention have found that, by adding a predetermined amount of bismuth to a samarium-iron-nitrogen magnet powder and making a magnet powder including a main phase containing bismuth, that is, by making a samarium-iron-bismuth-nitrogen magnet powder, the decomposition temperature is increased while maintaining a high coercivity of the samarium-iron-nitrogen magnet powder.

It is considered that this is because by a main phase containing bismuth, the stability of the crystal structure is enhanced. Although the reasons for this are unclear, it is possible that bismuth may extend and contract lattice constants in a direction of stabilizing the crystal structure of the main phase, or that bismuth may react with oxygen and nitrogen near the surface of the main phase to suppress decomposition near the surface of the main phase.

In fact, it has been confirmed that, with respect to a samarium-iron-bismuth-nitrogen magnet powder, as the additive amount of bismuth increases, the lattice constant a decreases and the lattice constant c increases. It is considered that by replacing a predetermined amount of samarium and/or iron included in the main phase with bismuth, the stability of the crystal structure is enhanced and the decomposition of the samarium-iron-bismuth-nitrogen magnet powder is suppressed.

Also, it is preferable that the nitrogen release temperature of the samarium-iron-bismuth-nitrogen magnet powder is high. Because the proper arrangement of bismuth in the main phase changes depending on nitriding conditions, the content of nitrogen, the distribution of nitrogen, or the like, the proper arrangement of bismuth in the main phase may be determined by measuring the nitrogen release temperature of the samarium-iron-bismuth-nitrogen magnet powder.

Further, it is preferable that, in the samarium-iron-bismuth-nitrogen magnet powder, at least part of a surface of the main phase is coated with a coating layer including samarium, iron, and bismuth, and the atomic ratio of rare earth elements to iron group elements in the coating layer is greater than the atomic ratio of rare earth elements to iron group elements in the main phase. Thereby, the decomposition of the samarium-iron-bismuth-nitrogen magnet powder is considered to be further suppressed.

As described above, because the samarium-iron-bismuth-nitrogen magnet powder has high stability of a crystal structure, the decomposition temperature can be enhanced while maintaining a high coercivity of the samarium-iron-nitrogen magnet powder.

[Samarium-Iron-Bismuth-Nitrogen-Based Magnet Powder]

A samarium-iron-bismuth-nitrogen-based magnet powder according to the present embodiment includes a main phase including samarium, iron, and bismuth. Therefore, it is possible to maintain a high coercivity of a samarium-iron-nitrogen-based magnet powder.

The ratio of bismuth (the amount of bismuth) to the total amount of samarium, iron, and bismuth of the samarium-iron-bismuth-nitrogen-based magnet powder according to the present embodiment is less than or equal to 3.0 at % and is preferably less than or equal to 0.68 at % (excluding 0 at %). If the ratio of bismuth to the. total amount of samarium, iron, and bismuth of the samarium-iron-bismuth-nitrogen-based magnet powder exceeds 3.0 at %, the decomposition temperature of the samarium-iron-bismuth-nitrogen-based magnet powder decreases. It is considered that due to excess bismuth, the crystal structure of the samarium-iron-bismuth-nitrogen-based magnet powder may become unstable, and many subphases such as α-Fe may be generated.

The nitrogen release temperature of the samarium-iron-bismuth-nitrogen-based magnet powder according to the present embodiment is preferably greater than or equal to 610° C., and is more preferably greater than or equal to 630° C. When the nitrogen release temperature of the samarium-iron-bismuth-nitrogen-based magnet powder is greater than or equal to 610° C., the decomposition temperature of the samarium-iron-bismuth-nitrogen-based magnet powder further increases.

According to the present embodiment, it is preferable that the coercivity of the samarium-iron-bismuth-nitrogen-based magnet powder before being heat-treated is greater than or equal to 20 kOe. When the coercivity of the samarium-iron-bismuth-nitrogen-based magnet powder before being heat-treated is greater than or equal to 20 kOe, the samarium-iron-bismuth-nitrogen-based magnet powder can also be used for high temperature applications.

The crystal structure of the main phase of the samarium-iron-bismuth-nitrogen-based magnet powder according to the present embodiment may be either a Th₂Zn₁₇ structure or a TbCu₇ structure, and may preferably be a Th₂Zn₁₇ structure.

The samarium-iron-bismuth-nitrogen-based magnet powder according to the present embodiment may include one or more subphases, such as a coating layer, in addition to the main phase.

Note that in the ratio of bismuth to the total amount of samarium, iron, and bismuth, the total amount of samarium, iron, and bismuth and the amount of bismuth mean the amount contained in the entire samarium-iron-bismuth-nitrogen-based magnet powder including the main phase and the subphase(s).

Here, when the samarium-iron-bismuth-nitrogen-based magnet powder contains soft magnetic iron, the magnetic properties decrease. Therefore, at the time of manufacturing, the amount of samarium is added in excess of the stoichiometric ratio.

The samarium-iron-bismuth-nitrogen-based magnet powder according to the present embodiment may further include one or more rare-earth elements such as neodymium and praseodymium other than samarium, and one or more iron group elements such as cobalt other than iron.

It is preferable that the content of rare earth elements other than samarium in all rare earth elements and the content of iron group elements other than iron in all iron group elements are each less than 30 at % in terms of anisotropic magnetic field and magnetization.

Also, rare earth elements other than samarium and iron group elements other than iron may be included in both of a main phase and a sub-phase, and may be included in either a main phase or a sub-phase.

It is preferable that in the samarium-iron-bismuth-nitrogen-based magnet powder according to the present embodiment, at least part of a surface of the main phase is coated with a coating layer including samarium, iron, and bismuth, and the atomic ratio of rare earth elements to iron group elements in the coating layer is greater than the atomic ratio of rare earth elements to iron group elements in the main phase. Thereby, the decomposition temperature of the samarium-iron-bismuth-nitrogen-based magnet powder is further increased.

[Method of Manufacturing Samarium-Iron-Bismuth-Nitrogen-Based Magnet Powder]

A method of manufacturing a samarium-iron-bismuth-nitrogen-based magnet powder according to the present embodiment includes a step of reducing and diffusing a precursor powder of a samarium-iron-bismuth-based alloy under an inert gas atmosphere to prepare a samarium-iron-bismuth-based alloy powder, and a step of nitriding the samarium-iron-bismuth-based alloy powder.

Note that examples of the inert gas include argon and the like. Here, because it is necessary to control the nitriding amount of the samarium-iron-bismuth-nitrogen-based magnet powder, it is necessary to avoid the use of nitrogen gas at the time of reduction and diffusion.

Also, in the inert gas atmosphere, it is preferable that the oxygen concentration is controlled to be less than or equal to 1 ppm by a gas purifier or the like.

In the following, the method of manufacturing a samarium-iron-bismuth-nitrogen-based magnet powder according to the present embodiment will be specifically described.

[Precursor Powder of Samarium-Iron-Bismuth-Based Alloy]

A precursor powder of the samarium-iron-bismuth-based alloy is not particularly limited as long as it is possible to generate a samarium-iron-bismuth-based alloy powder by reduction and diffusion. The precursor powder of the samarium-iron-bismuth-based alloy may be a samarium-iron-bismuth-based oxide powder, a samarium-iron-bismuth-based hydroxide powder, or the like. Two or more kinds may be used in combination as the precursor powder of the samarium-iron-bismuth-based alloy.

In the following, a samarium-iron-bismuth-based oxide powder and/or a samarium-iron-bismuth-based hydroxide powder is referred to as a samarium-iron-bismuth-based (hydro) oxide powder.

Also, a samarium-iron-bismuth-based alloy powder means a powder of an alloy containing samarium, iron, and bismuth.

A samarium-iron-bismuth-based (hydro) oxide powder may be prepared by a coprecipitation process. Specifically, first, a precipitating agent, such as alkali, is added to a solution containing samarium salt, iron salt, and bismuth salt to precipitate. After the precipitation, the precipitate is collected by filtration, centrifugation, or the like. Subsequently, the precipitate is washed and then dried. Furthermore, the precipitate is roughly milled in a blade mill or the like, and then pulverized in a bead mill or the like to obtain a samarium-iron-bismuth-based (hydro) oxide powder.

Here, when the bismuth salt is added, the pH is adjusted to be acid to dissolve the bismuth salt.

When adjusting the pH to be acid, it is preferable to use a strong acid, such as nitric acid.

Note that counter ions with respect to the samarium salt, the iron salt, and the bismuth salt may be inorganic ions such as chloride ions, sulfate ions, and nitrate ions, and may be organic ions such as alkoxide.

As a solvent contained in the solution containing the samarium salt, the iron salt and the bismuth salt, water may be used, or an organic solvent such as ethanol may be used.

As the alkali, a hydroxide of an alkali metal and an alkaline earth metal and ammonia may be used, or a compound such as urea that has an effect as a precipitating agent by decomposition due to external action such as heat or the like may be used.

At the time of drying the washed precipitate, a hot air oven may be used or a vacuum dryer may be used.

Note that after preparing the precursor powder of the samarium-iron-bismuth-based alloy, steps are performed in a glovebox or the like without exposure to air until a samarium-iron-bismuth-nitrogen-based magnet powder is obtained.

[Pre-Reduction]

Before reducing and diffusing the samarium-iron-bismuth-based (hydro) oxide powder, the samarium-iron-bismuth-based (hydro) oxide powder is preferably pre-reduced in a reducing atmosphere, such as a hydrogen atmosphere. Thereby, the amount of calcium used can be reduced and generation of coarse samarium-iron-bismuth-based alloy particles can be suppressed.

A method of pre-reducing the samarium-iron-bismuth-based (hydro) oxide powder is not particularly limited, and may be a method of heat treatment at a temperature greater than or equal to 400° C. in a reducing atmosphere, such as a hydrogen atmosphere.

In order to obtain a samarium-iron-bismuth-based alloy powder whose particle diameters are uniform and having an average particle diameter of 3 μm or less, the samarium-iron-bismuth-based (hydro) oxide powder is pre-reduced at 500° C. to 800° C. Thereby, it is possible to obtain a precursor powder of a samarium-iron-bismuth-based alloy.

[Reduction and Diffusion]

A method of reducing and diffusing the precursor powder of the samarium-iron-bismuth-based alloy under an inert gas atmosphere is not limited particularly, and may be a method of mixing calcium or calcium hydride with the precursor powder of the samarium-iron-bismuth-based alloy and then heating the mixture to a temperature that is greater than or equal to the melting point of calcium (approximately 850° C.), or the like. At this time, samarium reduced by calcium diffuses in the calcium melt and reacts with iron and bismuth to generate a samarium-iron-bismuth-based alloy powder.

There is a correlation between the temperature of reduction and diffusion and the particle size of the samarium-iron-bismuth-based alloy powder, and as the temperature of reduction and diffusion increases, the particle size of the samarium-iron-bismuth-based alloy powder increases.

In order to obtain a samarium-iron-bismuth-based alloy powder whose particle diameters are uniform and having an average particle diameter of 3 μm or less, a samarium-iron-bismuth-based oxide powder is reduced and diffused at 850° C. to 1050° C. for 1 minute to 2 hours under an inert gas atmosphere.

The samarium-iron-bismuth-based oxide powder crystallizes as reduction and diffusion progresses, and a main phase having a Th₂Zn₁₇ structure is formed. At this time, a coating layer is formed on at least part of the surface of the main phase.

Note that the coating layer can be removed, for example, by a process with a dilute aqueous acetic acid solution.

[Nitriding]

A method of nitriding the samarium-iron-bismuth-based alloy powder is not particularly limited, and may be a method of heat-treating the samarium-iron-bismuth-based alloy powder under an atmosphere of ammonia, a mixed gas of ammonia and hydrogen, nitrogen, or a mixed gas of nitrogen and hydrogen, at 300° C. to 500° C., or the like.

In general, for the main phase of a samarium-iron-nitrogen-based magnet powder, a composition of Sm₂Fe₁₇N₃ is known to be suitable in order to exhibit high magnetic properties. Therefore, for the main phase of the samarium-iron-bismuth-nitrogen-based magnet powder according to the present embodiment, a composition in which Sm and/or Fe of Sm₂Fe₁₇N₃ is replaced with Bi is optimal.

Note that in a case where ammonia is used, the samarium-iron-bismuth-based alloy powder can be nitridated in a short time, but there is a possibility that the nitrogen content in the samarium-iron-bismuth-nitrogen-based magnet powder becomes higher than the optimum value. In this case, excess nitrogen can be discharged from the crystalline lattice by nitriding the samarium-iron-bismuth-based alloy powder and then annealing in hydrogen.

For example, the samarium-iron-bismuth-based alloy powder is heat-treated at 350° C. to 450° C. for 10 minutes to 2 hours under an ammonia-hydrogen mixture atmosphere, and then annealed at 350° C. to 450° C. for 30 minutes to 2 hours under a hydrogen atmosphere. Thereby, the nitrogen content in the samarium-iron-bismuth-nitrogen-based magnet powder can be made proper.

[Washing]

The samarium-iron-bismuth-nitrogen-based magnet powder includes a calcium compound such as calcium oxide, unreacted metal calcium, calcium nitride that is nitrided metal calcium, or calcium hydride. In this case, it is preferable to wash the samarium-iron-bismuth-nitrogen-based magnet powder with a solvent capable of dissolving a calcium compound to remove the calcium compound.

A solvent capable of dissolving a calcium compound is not particularly limited, and may be water, alcohol, or the like. In particular, in terms of cost and solubility of a calcium compound, water is preferable.

For example, most of the calcium compound can be removed by repeating an operation of, after adding water to the samarium-iron-bismuth-nitrogen-based magnet powder, conducting stirring and decantation.

Note that the samarium-iron-bismuth-based alloy powder may be washed to remove the calcium compound before nitriding the samarium-iron-bismuth-based alloy powder.

[Vacuum Drying]

It is preferable that the washed samarium-iron-bismuth-nitrogen-based magnet powder is vacuum-dried in order to remove the solvent capable of dissolving the calcium compound.

The temperature at which the washed samarium-iron-bismuth-nitrogen-based magnet powder is vacuum-dried is preferably between ambient temperature and 100° C. In this way, oxidation of the washed samarium-iron-bismuth-nitrogen-based magnet powder can be suppressed.

Note that the washed samarium-iron-bismuth-nitrogen-based magnet powder may be vacuum-dried after replacement with an organic solvent such as alcohol that is highly volatile and is miscible with water.

[Dehydrogenation]

At the time of washing the samarium-iron-bismuth-nitrogen-based magnet powder, hydrogen may enter between crystal lattices. In this case, it is preferred to dehydrogenate the samarium-iron-bismuth-nitrogen-based magnet powder.

A method of dehydrogenating the samarium-iron-bismuth-nitrogen-based magnet powder is not particularly limited, and may be a method of heat-treating the samarium-iron-bismuth-nitrogen-based magnet powder under vacuum or an inert gas atmosphere or the like.

For example, under an argon atmosphere, the samarium-iron-bismuth-nitrogen-based magnet powder is heat-treated at 150° C. to 450° C. for 0 to 1 hour.

[Pulverization]

The samarium-iron-bismuth-nitrogen based magnet powder may be pulverized. Thereby, the remanence and the maximum energy product of the samarium-iron-bismuth-nitrogen-based magnet powder are enhanced.

When pulverizing the samarium-iron-bismuth-nitrogen-based magnet powder, it is possible to use a jet mill, a dry ball mill, a wet ball mill, a vibration mill, a medium stirring mill, and the like.

Note that a samarium-iron-bismuth-based alloy powder may be pulverized instead of pulverizing the samarium-iron-bismuth-nitrogen-based magnet powder.

[Samarium-Iron-Bismuth-Nitrogen-Based Sintered Magnet and Manufacturing Method]

According to the present embodiment, a samarium-iron-bismuth-nitrogen-based sintered magnet includes a main phase including samarium, iron, and bismuth, wherein a ratio of bismuth to the total amount of samarium, iron, and bismuth is less than or equal to 3.0 at %, and can be manufactured using a samarium-iron-bismuth-nitrogen-based magnet powder according to the present embodiment. Therefore, a high performance magnet can be manufactured.

In a method of manufacturing a samarium-iron-bismuth-nitrogen-based sintered magnet according to the present embodiment, for example, a samarium-iron-bismuth-nitrogen-based magnet powder according to the present embodiment is molded into a predetermined shape and then sintered.

[Molding]

At the time of molding, while applying a magnetic field, the samarium-iron-bismuth-nitrogen-based magnet powder according to the embodiment may be molded. Thereby, because a compact (molded body) of the samarium-iron-bismuth-nitrogen-based magnet powder according to the present embodiment is oriented in a specific direction, an anisotropic magnet with high magnetic properties is obtained.

[Sintering]

Upon sintering a compact of the samarium-iron-bismuth-nitrogen-based magnet powder according to the present embodiment, a samarium-iron-bismuth-nitrogen-based sintered magnet according to the present embodiment is obtained.

A method of sintering the compact of the samarium-iron-bismuth-nitrogen-based magnet powder according to the present embodiment is not particularly limited, and may be a discharge plasma method, a hot press method, or the like.

Note that molding of the samarium-iron-bismuth-nitrogen-based magnet powder according to the present embodiment and sintering of the compact of the samarium-iron-bismuth-nitrogen-based magnet powder according to the present embodiment may be performed using a same apparatus.

### EXAMPLES

In the following, Examples of the present invention will be described. The present invention is not limited to Examples described below.

### Example 1

(Preparation of Samarium-Iron-Bismuth (Hydro) Oxide Powder)

63.99 g of iron nitrate nonahydrate, 0.78 g of bismuth nitrate pentahydrate, and 12.93 g of samarium nitrate hexahydrate were dissolved in 800 ml of water, and then 10 ml of nitric acid was added and it was stirred for 3 hours. Then, while stirring, after dropping 120 ml of 2 mol/L potassium hydroxide solution, it was stirred at ambient temperature overnight to prepare a suspension. Next, the suspension was filtered and the filtered sample was washed and then dried overnight at 120° C. under an air atmosphere using a hot air oven. The obtained sample was coarsely pulverized with a blade mill and finely pulverized in ethanol with a rotary mill using a stainless steel ball. Next, after centrifuging the finely pulverized sample, it was vacuum-dried to prepare a samarium-iron-bismuth (hydro) oxide powder.

(Pre-Reduction)

The samarium-iron-bismuth (hydro) oxide powder was pre-reduced by heat treatment under a hydrogen atmosphere at 600° C. for 6 hours to prepare a samarium-iron-bismuth oxide powder.

(Reduction and Diffusion)

After 5 g of the samarium-iron-bismuth oxide powder and 2.5 g of metal calcium were placed in an iron crucible, it was heated at 900° C. for 1 hour to be reduced and diffused such that a samarium-iron-bismuth alloy powder was prepared.

(Nitriding)

After cooling the samarium-iron-bismuth alloy powder to ambient temperature, under a hydrogen atmosphere, it was heated to 380° C. Then, under an ammonia-hydrogen mixture atmosphere whose volume ratio is 1:2, it was heated to 420° C. to be maintained for 1 hour so that the samarium-iron-bismuth alloy powder was nitrided to prepare a samarium-iron-bismuth-nitrogen magnet powder. Further, the nitrogen content in the samarium-iron-bismuth-nitrogen magnet powder was adjusted (optimized) by annealing the samarium-iron-bismuth-nitrogen magnet powder under a hydrogen atmosphere at 420° C. for 1 hour, and then annealing the samarium-iron-bismuth-nitrogen magnet powder under an argon atmosphere at 420° C. for 0.5 hours.

(Washing)

The samarium-iron-bismuth-nitrogen magnet powder, whose nitrogen content was adjusted, was washed with pure water five times to remove a calcium compound and the like.

(Vacuum-Drying)

Water remaining in the washed samarium-iron-bismuth-nitrogen magnet powder was replaced with 2-propanol and then the powder was vacuum-dried at ambient temperature.

(Dehydrogenation)

The vacuum-dried samarium-iron-bismuth-nitrogen magnet powder was dehydrogenated under vacuum at 200° C. for 3 hours.

Note that steps subsequent to pre-reduction were performed in a glove box under an argon atmosphere without exposure to air.

### Example 2

In (Preparation of Samarium-Iron-Bismuth (Hydro) Oxide Powder), a samarium-iron-bismuth-nitrogen magnet powder was prepared similarly to Example 1, except that the additive amounts of iron nitrate nonahydrate and bismuth nitrate pentahydrate were changed to 58.18 g and 7.76 g, respectively.

### Example 3

In (Preparation of Samarium-Iron-Bismuth (Hydro) Oxide Powder), a samarium-iron-bismuth-nitrogen magnet powder was prepared similarly to Example 1, except that the additive amounts of iron nitrate nonahydrate and bismuth nitrate pentahydrate were changed to 55.47 g and 11.01 g, respectively.

### Example 4

Bismuth nitrate pentahydrate was dissolved in advance in an aqueous nitric acid solution to prepare a bismuth nitrate solution (concentration of bismuth nitrate: 1 g/100 ml).

In (Preparation of Samarium-Iron-Bismuth (Hydro) Oxide Powder), a samarium-iron-bismuth-nitrogen magnet powder was prepared similarly to Example 1, except that the additive amount of iron nitrate nonahydrate was changed to 64.63 g and 0.8 ml of the bismuth nitrate solution was added in place of bismuth nitrate pentahydrate.

### Example 5

In (Preparation of Samarium-Iron-Bismuth (Hydro) Oxide Powder), a samarium-iron-bismuth-nitrogen magnet powder was prepared similarly to Example 1, except that the additive amount of iron nitrate nonahydrate was changed to 64.58 g and 7.8 ml of the bismuth nitrate solution (see Example 4) was added in place of bismuth nitrate pentahydrate.

### Example 6

In (Preparation of Samarium-Iron-Bismuth (Hydro) Oxide Powder), a samarium-iron-bismuth-cobalt-nitrogen magnet powder was prepared similarly to Example 1, except that the additive amounts of iron nitrate nonahydrate and bismuth nitrate pentahydrate were changed to 57.53 g and 0.78 g, respectively, and 4.66 g of cobalt nitrate hexahydrate was further added.

### Example 7

In (Preparation of Samarium-Iron-Bismuth (Hydro) Oxide Powder), a samarium-iron-bismuth-cobalt-nitrogen magnet powder was prepared similarly to Example 1, except that the additive amounts of iron nitrate nonahydrate and bismuth nitrate pentahydrate were changed to 51.71 g and 7.76 g, respectively, and 4.66 g of cobalt nitrate hexahydrate was further added.

### Example 8

A samarium-iron-bismuth-nitrogen magnet powder was prepared similarly to Example 2 except that the coating layer was removed between (Washing) and (Vacuum drying) as follows.

(Removal of Coating Layer)

The coating layer was removed by adding a dilute acetic acid aqueous solution to the washed samarium-iron-bismuth-nitrogen magnet powder to have a pH of 5.5 and by holding it for 15 minutes.

### Comparative Example 1

In (Preparation of Samarium-Iron-Bismuth (Hydro) Oxide Powder), a samarium-iron-bismuth-nitrogen magnet powder was prepared similarly to Example 1, except that the additive amount of iron nitrate nonahydrate was changed to 64.64 g and bismuth nitrate pentahydrate was not added.

### Comparative Example 2

In (Preparation of Samarium-Iron-Bismuth (Hydro) Oxide Powder), a samarium-iron-bismuth-nitrogen magnet powder was prepared similarly to Example 1, except that the additive amounts of iron nitrate nonahydrate and bismuth nitrate pentahydrate were changed to 51.71 g and 15.52 g, respectively.

### Comparative Example 3

A samarium-iron-titanium-nitrogen magnet powder was prepared similarly to Example 1 except that a samarium-iron-titanium (hydro) oxide powder was prepared as follows instead of preparing the samarium-iron-bismuth (hydro) oxide powder.

(Preparation of Samarium-Iron-Titanium (Hydro) Oxide Powder)

A samarium-iron-titanium (hydro) oxide powder was prepared similarly to (Preparation of Samarium-Iron-Bismuth (Hydro) Oxide Powder) except that 62.35 g of iron nitrate nonahydrate and 12.93 g of samarium nitrate hexahydrate were dissolved in 800 ml of water, and then a solution obtained by dissolving 1.61 g of titanium tetraisopropoxide in 2-propanol was added and it was stirred for 3 hours.

### Comparative Example 4

A samarium-iron-copper-nitrogen magnet powder was prepared similarly to Example 1 except that a samarium-iron-copper (hydro) oxide powder was prepared as follows instead of preparing the samarium-iron-bismuth (hydro) oxide powder.

(Preparation of Samarium-Iron-Copper (Hydro) Oxide Powder)

A samarium-iron-copper (hydro) oxide powder was prepared similarly to (Preparation of Samarium-Iron-Bismuth (Hydro) Oxide Powder) except that 62.35 g of iron nitrate nonahydrate, 1.37 g of copper nitrate trihydrate and 12.93 g of samarium nitrate hexahydrate were dissolved in 800 ml of water, and then 10 ml of nitric acid was added and it was stirred for 3 hours.

### Comparative Example 5

(Preparation of Samarium-Iron-Nitrogen Magnet Powder)

Similarly to Comparative Example 1, a samarium-iron-nitrogen magnet powder was prepared.

(Coating With Bismuth)

2 g of the samarium-iron-nitrogen magnet powder, 1 g of metal calcium, and 0.95 g of bismuth oxide were placed in an iron crucible and then reduced by heating at 860° C. for 1 hour to coat the surface of the samarium-iron-nitrogen magnet powder with bismuth. Here, the reduction temperature was set to 860° C., which is slightly higher than the melting point (842° C.) of calcium, in consideration of the decomposition temperature (620° C.) of the main phase and the efficiency of the reduction reaction.

Thereafter, similarly to Example 1, (Washing), (Vacuum-Drying), and (Dehydrogenation) were performed to prepare a samarium-iron-nitrogen magnet powder having a surface coated with bismuth.

Next, X-ray diffraction (XRD) spectra of the magnet powders of Examples 1 to 8 and Comparative Examples 1 to 4 were measured, and it was confirmed that the main phases of the magnet powders of Examples 1 to 8 and Comparative Examples 1 to 4 had a Th₂Zn₁₇ structure. Also, the nitrogen contents of the magnet powders of Examples 1 to 8 and Comparative Examples 1 to 4 were measured by an inert gas melting-thermal conductivity technique. It was confirmed that the nitrogen contents were each approximately 3.3 wt %, and for the magnet powders of Examples 1 to 8 and Comparative Examples 1 to 4, the nitrogen contents were suitable for expressing high magnetic properties.

Next, the compositions of the magnet powders of Examples 1 to 8 and Comparative Examples 1 to 5 were analyzed.

[Composition]

The compositions of the magnet powders were analyzed by high frequency inductively coupled plasma emission spectroscopy.

Note that in a case where the ratio of bismuth to the total amount of samarium, iron, and bismuth exceeds 0 at % but is less than 0.01 at % in this analysis, although it can be detected, it was described as “<0.01” in Table 1 because of a large margin of analysis error.

Next, the nitrogen release temperature, the decomposition temperature, and the coercivity of the magnet powder for each of Examples 1 to 8 and Comparative Examples 1 to 5 were measured.

[Nitrogen Release Temperature and Decomposition Temperature]

The nitrogen release temperature and the decomposition temperature of the magnet powder were measured by a thermogravimetry device connected with a mass spectrometer. The measurement conditions were set such that a temperature rise rate was 5° C./minute under an argon atmosphere.

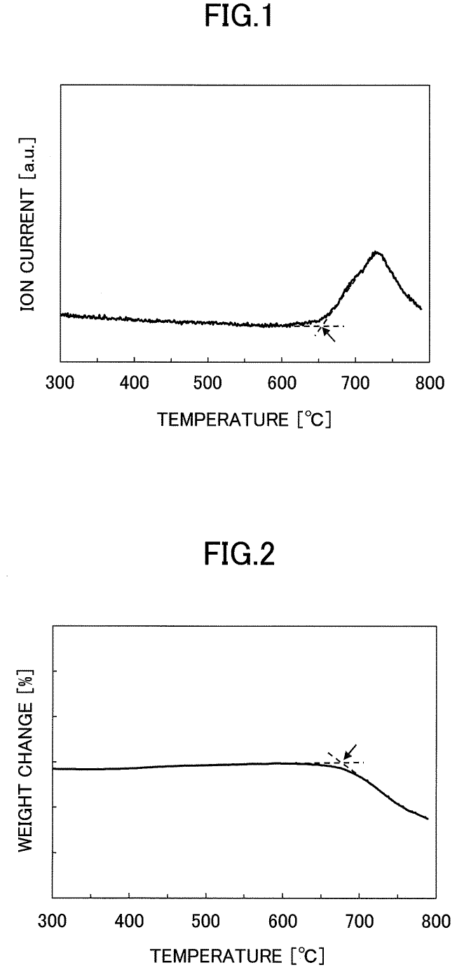

FIG. 1 indicates the measurement result of the nitrogen release temperature of the samarium-iron-bismuth-nitrogen magnet powder of Example 1. FIG. 1 indicates ion current change as a function of temperature due to N₂⁺ whose mass-to-charge ratio (m/z) is 28. In FIG. 1, two auxiliary lines are drawn, and the nitrogen release temperature was obtained from the intersection of the two lines.

Here, the two auxiliary lines are a straight line drawn using the values of ion current of 500° C. to 550° C. and a straight line drawn using the values of ion current of ±10° C. from a predetermined point where the slope value is largest. Note that in a case where a straight line cannot be drawn using the values of ion current of 500° C. to 550° C., a straight line was drawn using the values of ion current of 450° C. to 500° C.

FIG. 2 indicates the measurement result of the decomposition temperature of the samarium-iron-bismuth-nitrogen magnet powder of Example 1. FIG. 2 indicates a weight change due to heating of the samarium-iron-bismuth-nitrogen magnet powder. In FIG. 2, two auxiliary lines were drawn and the decomposition temperature was obtained from the intersection of the lines.

Here, the two auxiliary lines are a straight line drawn using the values of weight of 500° C. to 550° C. and a straight line drawn using the values of weight of ±10° C. from a predetermined point where the slope value is largest. Note that in a case where a straight line cannot be drawn using the values of weight of 500° C. to 550° C., a horizontal auxiliary line was drawn using the values of weight of 450° C. to 500° C.

[Coercivity Before Heat Treatment]

The magnet powder was mixed with a thermoplastic resin and oriented in a magnetic field of 20 kOe to prepare a sample. Next, using a vibration sample magnetometer (VSM), under conditions of a temperature of 27° C. and a maximum applied magnetic field of 90 kOe, the sample was arranged in an easily magnetizable axial direction and the coercivity of the magnet powder before heat treatment was measured.

[Coating Layer]

A portion of the magnet powder was collected to be mixed with a thermosetting epoxy resin and thermally cured. Then, it was irradiated with a focused ion beam (FIB) and etched to expose a cross-section to create a sample.

A scanning electron microscope (FE-SEM) was used to observe the sample to determine the presence or absence of a coating layer.

Note that when the compositions of the main phase and the coating layer of a magnet powder with the coating layer were analyzed by energy dispersive X-ray spectroscopy (EDS), it was found that the atomic ratio of rare earth elements to iron group elements in the coating layer was larger than the atomic ratio of rare earth elements to iron group elements in the main phase.

Here, the main phase and the coating layer can be distinguished by a FE-SEM reflective electron image or EDS mapping.

Table 1 indicates the composition, the presence/absence of cobalt, titanium, and copper, the nitrogen release temperature, the coercivity before heat treatment, the decomposition temperature, and the presence/absence of a coating layer for each magnet powder.

TABLE 1

| | RATIO OF Bi | | | | | | | |
|---|---|---|---|---|---|---|---|---|
| | TO TOTAL | | | | | | | |
| | AMOUNT | | | | NITROGEN | | COERCIVITY | |
| | OF Sm, Fe, | | | | RELEASE | DECOMPOSITION | BEFORE HEAT | |
| | AND Bi | | | | TEMPERATURE | TEMPERATURE | TREATMENT | COATING |
| | [at %] | Co | Ti | Cu | [° C.] | [° C.] | [kOe] | LAYER |
| E1 | 0.13 | ABSENT | ABSENT | ABSENT | 652 | 671 | 29.9 | PRESENT |
| E2 | 0.68 | ABSENT | ABSENT | ABSENT | 651 | 671 | 26.2 | PRESENT |
| E3 | 2.99 | ABSENT | ABSENT | ABSENT | 625 | 641 | 26.9 | PRESENT |
| E4 | <0.01 | ABSENT | ABSENT | ABSENT | 657 | 677 | 29.9 | PRESENT |
| E5 | 0.02 | ABSENT | ABSENT | ABSENT | 651 | 666 | 29.9 | PRESENT |
| E6 | 0.13 | PRESENT | ABSENT | ABSENT | 661 | 667 | 24.7 | PRESENT |
| E7 | 0.68 | PRESENT | ABSENT | ABSENT | 657 | 658 | 30.1 | PRESENT |
| E8 | 0.35 | ABSENT | ABSENT | ABSENT | 621 | 636 | 20.9 | ABSENT |
| CE1 | 0.00 | ABSENT | ABSENT | ABSENT | 602 | 618 | 30.6 | ABSENT |
| CE2 | 8.26 | ABSENT | ABSENT | ABSENT | 567 | 572 | 27.5 | PRESENT |
| CE3 | 0.00 | ABSENT | PRESENT | ABSENT | 538 | 522 | 2.7 | ABSENT |
| CE4 | 0.00 | ABSENT | ABSENT | PRESENT | 546 | 553 | 8.6 | ABSENT |
| CE5 | 8.50 | ABSENT | ABSENT | ABSENT | — | — | 0.9 | ABSENT |

From Table 1, it can be seen that the samarium-iron-bismuth-nitrogen magnet powders of Examples 1 to 6 have a high coercivity before heat treatment and a high decomposition temperature.

On the other hand, because the samarium-iron-nitrogen magnet powder of Comparative Example 1 does not contain bismuth, the decomposition temperature is low.

The decomposition temperature of the samarium-iron-bismuth-nitrogen magnet powder of Comparative Example 2 is low because the ratio of bismuth to the total amount of samarium, iron, and bismuth is 8.26 at %.

Because the samarium-iron-titanium-nitrogen magnet powder of Comparative Example 3 does not contain bismuth but contains titanium, the coercivity before heat treatment and the decomposition temperature are low.

Because the samarium-iron-copper-nitrogen magnet powder of Comparative Example 4 does not contain bismuth but contains copper, the coercivity before heat treatment and the decomposition temperature are low.

For the samarium-iron-nitrogen magnet powder of Comparative Example 5 having a surface covered with bismuth, the coercivity before heat treatment was extremely low, and the nitrogen release temperature and the decomposition temperature could not be determined. When the X-ray diffraction (XRD) spectra of the samarium-iron-nitrogen magnet powder having a surface coated with bismuth in Comparative Example 5 were measured, a SmN phase and an α-Fe phase were confirmed, thus it is considered that the main phase was decomposed.

Next, the lattice constants of the magnet powders of Examples 1 and 2 and Comparative Examples 1 and 2 were measured.

[Lattice Constant]

A borosilicate glass capillary with an inner diameter of 0.3 mm was filled with the magnet powder. Then, X-ray diffraction was measured by a Synchrotron Radiation X-ray diffraction method (transmission method) using a large Debye-Scherrer camera at the beam line BL02B2 of SPring-8 (manufactured by Japan Synchrotron Radiation Research Institute (JASRI). At this time, the wavelength of X-ray was set to 0.495046 Å, an imaging plate was used as a detector, the exposure time was set to 10 minutes, and the measurement temperature was set to ambient temperature.

Table 2 indicates the measurement results of the lattice constants of the magnet powders.

TABLE 2

| | RATIO OF Bi TO | | |
|---|---|---|---|
| | TOTAL AMOUNT OF | | |
| | Sm, Fe, AND Bi [at %] | a [Å] | c [Å] |
| E1 | 0.13 | 8.7423 | 12.6610 |
| E2 | 0.68 | 8.7422 | 12.6612 |
| CE1 | 0.00 | 8.7424 | 12.6609 |
| CE2 | 8.26 | 8.7414 | 12.6634 |

From Table 2, it can be seen that as the ratio of bismuth to the total amount of samarium, iron and bismuth increases, the lattice constant a of the magnet powder decreases and the lattice constant c increases. This suggests that part of samarium and/or iron included in the main phase is substituted with bismuth.

Next, the coercivity of the magnet powder after heat treatment was measured for each of Examples 1 to 5 and Comparative Examples 1, 2, and 5.

[Coercivity After Heat Treatment]

Using a heat treatment device installed in a glove box, part of the magnet powder was collected to be heat-treated for 5 minutes at 550° C. under a vacuum atmosphere. Then, it was mixed with a thermoplastic resin, and oriented in a magnetic field of 20 kOe to prepare a sample. Next, using a vibration sample magnetometer (VSM), under conditions of a temperature of 27° C. and a maximum applied magnetic field of 90 kOe, the sample was arranged in an easily magnetizable axial direction and the coercivity of the magnet powder was measured.

Next, sintered magnets were prepared using the magnet powders of Examples 1 to 5 and Comparative Examples 1, 2, and 5.

[Preparation of Sintered Magnet]

Here, isotropic sintered magnets were prepared.

Specifically, in a glove box, a cuboid die made of cemented carbide having a vertical length of 5.5 mm and a horizontal length of 5.5 mm was filled with 0.5 g of magnet powder. Thereafter, it was placed in a discharge plasma sintering apparatus provided with a pressurizing mechanism by a servo-controlled press device without exposure to air. Next, in a state in which the discharge plasma sintering apparatus was vacuumed (pressure of 2 Pa or less and oxygen concentration of 0.4 ppm or less), under conditions of a pressure of 1200 MPa and a temperature of 550° C., the magnet powder was energized and sintered for 1 minute to prepare a sintered magnet. Here, after the magnet powder was energized and sintered, the pressure was returned to the atmospheric pressure with an inert gas, and after the temperature became less than 60° C., the sintered magnet was taken out into the atmosphere.

By high frequency inductively coupled plasma emission spectroscopy, the composition of the sintered magnet was analyzed to confirm that the composition of the sintered magnet was equivalent to that of the magnet powder.

A scanning electron microscope (FE-SEM) was used to observe a cross-section of the sintered magnet to confirm that the composition of the coating layer, the composition of the main phase, and the coating of the surface of the main phase by the coating layer of the sintered magnet are equivalent to those of the magnet powder.

[Coercivity of Sintered Magnet]

A vibration sample magnetometer (VSM) was used to measure the coercivity of the sintered magnet under conditions of a temperature of 27° C. and a maximum applied magnetic field of 90 kOe.

TABLE 3

| | COERCIVITY | COERCIVITY | COERCIVITY OF |
|---|---|---|---|
| | BEFORE HEAT | AFTER HEAT | SINTERED |
| | TREATMENT | TREATMENT | MAGNET |
| | [kOe] | [kOe] | [kOe] |
| E1 | 29.9 | 10.3 | 9.8 |
| E2 | 26.2 | 9.7 | 9.3 |
| E3 | 26.9 | 9.2 | 8.8 |
| E4 | 29.9 | 10.5 | 10.0 |
| E5 | 29.9 | 10.3 | 9.8 |
| CE1 | 30.6 | 6.5 | 6.2 |
| CE2 | 27.5 | 4.2 | 4.1 |
| CE5 | 0.9 | 0.5 | 0.5 |

From Table 3, it can be seen that, for each of the magnet powders of Examples 1 to 5, the coercivity after heat treatment and the coercivity of the sintered magnet are high.

Here, it is considered that the coercivity of the magnet powder after heat treatment is lower than the coercivity of the magnet powder before heat treatment is due to an effect of a surface oxide layer.

On the other hand, for each of the magnet powders of Comparative Examples 1, 2, and 5, the coercivity after heat treatment and the coercivity of the sintered magnet are low. It is considered that this is due to localized decomposition of the magnet powders of Comparative Examples 1, 2, and 5 occurs near the surface of the main phase due to heat treatment or sintering at 550° C.

### INDUSTRIAL APPLICABILITY

In comparison with a neodymium magnet, a samarium-iron-bismuth-nitrogen magnet powder has a high Curie temperature and a small change in coercivity with respect to temperature. Therefore, it is possible to manufacture a samarium-iron-bismuth-nitrogen magnet having both high magnetic properties and heat resistance. For example, a samarium-iron-bismuth-nitrogen magnet is applied in home appliances such as air conditioners, production robots, automobiles, and the like. Also, a samarium-iron-bismuth-nitrogen magnet powder can be used as raw material of sintered magnets or bonded magnets used in motors, sensors, and the like that require high magnetic properties and heat resistance.

What is claimed is

1. A samarium-iron-bismuth-nitrogen-based magnet powder comprising:
a main phase including samarium, iron, and bismuth,
wherein a ratio of bismuth to a total amount of samarium, iron, and bismuth is less than or equal to 3.0 at %.

2. The samarium-iron-bismuth-nitrogen-based magnet powder according to claim 1, wherein a nitrogen release temperature is greater than or equal to than 610° C.

3. The samarium-iron-bismuth-nitrogen-based magnet powder according to claim 1,
wherein at least part of a surface of the main phase is coated with a coating layer including samarium, iron and bismuth, and
wherein an atomic ratio of rare earth elements to iron group elements in the coating layer is greater than an atomic ratio of rare earth elements to iron group elements in the main phase.

4. The samarium-iron-bismuth-nitrogen-based magnet powder according to claim 2,
wherein at least part of a surface of the main phase is coated with a coating layer including samarium, iron and bismuth, and
wherein an atomic ratio of rare earth elements to iron group elements in the coating layer is greater than an atomic ratio of rare earth elements to iron group elements in the main phase.

5. A samarium-iron-bismuth-nitrogen-based sintered magnet comprising:
a main phase including samarium, iron, and bismuth,
wherein a ratio of bismuth to a total amount of samarium, iron, and bismuth is less than or equal to 3.0 at %.
